(19) United States
(12) Patent Application Publication
(10) Pub. No.: US 2012/0044724 A1
(43) Pub. Date: Feb. 23, 2012

(54) SWITCHING POWER SUPPLY APPARATUS

(75) Inventors: Naohiko Morota, Hyogo (JP); Kazuhiro Murata, Hyogo (JP)

(73) Assignee: PANASONIC CORPORATION, Osaka (JP)

(21) Appl. No.: 13/265,994

(22) PCT Filed: Apr. 9, 2010
(86) PCT No.: PCT/JP2010/002609

§ 371 Date: Oct. 24, 2011

(30) Foreign Application Priority Data
Apr. 27, 2009 (JP) 2009-108548

(51) Int. Cl. H02M 3/335

(52) U.S. Cl. 363/21.17

(57) ABSTRACT

A switching power supply apparatus that can precisely control the overload protection voltage is provided. The apparatus includes a secondary current on-period detection circuit for detecting the time between turn-off of the switching device and off-timing of the secondary current; and an output power limiting circuit for comparing the output signal of the secondary current on-period detection circuit with a signal indicating a predetermined maximum secondary current on-period, and for outputting an output power limiting signal for reducing or stopping power supply to a load to a switching signal control circuit when the former signal is higher than the latter signal, wherein the maximum secondary current on-period is arranged to correspond to the secondary current on-period when the device current flowing through the switching device reaches the maximum current defined by the switching signal control circuit, or the oscillation frequency of the device current reaches the maximum oscillation frequency defined by the oscillator, and the second DC voltage from the output voltage generation circuit is released from constant-voltage control and reduced.

### TECHNICAL FIELD

The present invention relates to a switching power supply apparatus having a function of protecting against overload of the secondary side output for a load of the switching power supply apparatus.

### BACKGROUND ART

In recent years, the protection function against overload of the secondary side output for a load of a switching power supply has been an indispensable technology for the switching power supply used as a power supply apparatus for e.g., an electronic equipment.

As a technology for protecting against overload of the secondary side output, there is known a method in which a current to the load is monitored using e.g., a detection resistor for the secondary side, and an overload is detected by e.g., an IC for overload detection on the secondary side, then an overload signal is directly fed back to the primary side by e.g. a photo-coupler for overload signal output.

However, the above-mentioned IC for overload detection on the secondary side or the photo-coupler for overload signal output is expensive as a power supply unit, thereby increasing the cost of the switching power supply, and further preventing reduction of the size of the switching power supply. Now, Patent Literature 1 has introduced a technology which eliminates the need of the IC for overload detection on the secondary side or the photo-coupler for overload signal output, and detects an overload on the secondary side output by utilizing the phenomenon that the auxiliary winding voltage of a transformer varies according to the secondary side output voltage.

FIG. 13 shows a conventional switching power supply apparatus introduced in Patent Literature 1.

Also, in Patent Literature 1, the auxiliary winding voltage is rectified and smoothed, then is supplied as a circuit current to a control circuit. Such technology is generally known as power consumption reduction technology in contrast to the technique of supplying a circuit current from a high-voltage input line on the primary side.

The output voltage Vo is reduced at the time of an overload, and accordingly, the auxiliary power voltage VCC generated by rectifying and smoothing the auxiliary winding voltage is also reduced. In Patent Literature 1, when the auxiliary power voltage VCC is reduced to a certain value, an overload is detected and the drain current is limited according to the reduction in the auxiliary power voltage VCC. The more auxiliary power voltage VCC is reduced, the more drain current is reduced, which represents Japanese character [symbol] protection. Here, the “Japanese character [symbol] protection” referred to as a protection having a characteristics graph similar to the Japanese katakana character “ [symbol] ” where the graph is shown on the coordinate system with vertical axis representing voltage and the horizontal axis representing current.

Furthermore, Patent Literature 2 proposes a switching power supply apparatus that performs the constant-voltage control, constant-current control, and the Japanese character [symbol] protection function altogether on the primary side, which are needed for a charger, and eliminates the need of an IC for overload detection on the secondary side or a photo-coupler for feedback by combining the constant-voltage control through an auxiliary winding feedback and the constant-current control using the auxiliary winding voltage, and by further applying the overload protection technology introduced in Patent Literature 1.

### CITATION LIST

### Patent Literature

[PTL 1]
Japanese Patent Publication No. 3610964

[PTL 2]
Japanese Patent Publication No. 3973652

### SUMMARY OF INVENTION

### Technical Problem

However, the conventional technology has a problem in that the precision of the output voltage to be detected for overload is low. This is because the circuit current is supplied from the auxiliary winding, and also due to the fact that the output voltage Vo does not exactly have a direct proportional relationship with the auxiliary power voltage VCC.

Expression 1 shows the relationship between the output voltage Vo and the auxiliary power voltage VCC which is the voltage after the auxiliary winding voltage is rectified and smoothed.

### [MATH 1]

n×(Vo+Rdi×I2p)=VCC+Vbdi (Expression 1)

where I2p is the current flowing through a secondary winding T2, n is the turns ratio between the secondary winding and the auxiliary winding, Rdi is the resistance component of a secondary side rectifier diode, and Vbdi is the voltage drop across the rectifier diode of the auxiliary winding.

Here, in order to supply the circuit current from the auxiliary winding, the auxiliary power voltage VCC needs to be at least greater than a reference power voltage VDD of the control circuit. In general, when the auxiliary power voltage VCC falls below the reference power voltage VDD, it is maintained by a circuit current source other than the auxiliary winding.

When the reference power voltage VDD is lower than the overload detection voltage VCCOLP, no problem occurs where VCCOLP is assumed to be the voltage for overload detection set by the auxiliary power voltage VCC. Normally, the auxiliary power voltage VCC is set low as much as possible while being higher than the reference power voltage VDD in order to reduce the power consumption of the circuit, and the overload detection voltage VCCOLP is set sufficiently lower than the auxiliary power voltage VCC at the time of normal operation in order to secure a constant current region. Thus, in many cases, the overload detection voltage VCCOLP becomes lower than the reference power voltage VDD.

Accordingly, at the time of overload detection, the auxiliary power voltage VCC is once applied across the reference power voltage VDD and is reduced to less than the reference power voltage VDD, then an overload is detected.

Consequently, when the auxiliary power voltage VCC is higher than the reference power voltage VDD, Vbdi serves as a forward voltage of the rectifier diode, however, when the auxiliary power voltage VCC is lower than the reference power voltage VDD, the circuit current is not supplied from the auxiliary power voltage VCC to the reference power voltage VDD, thus almost no current flows through the rectifier diode of the auxiliary winding. Accordingly, the voltage drop Vbdi across the rectifier diode becomes almost 0 V.

Also, the voltage waveform of the auxiliary winding is not an ideal trapezoidal wave, and actually includes spike shaped noise due to the leakage inductance of the transformer. Particularly, when the auxiliary power voltage VCC is reduced to less than the reference power voltage VDD, and the voltage drop Vbdi across the rectifier diode is small, the spike shaped noise cannot be neglected, thus the above Expression 1 does not hold.

Thus, with the conventional technology, it is difficult to set the output voltage so as to perform overload protection with high precision, and also there is a problem in that the overload protection tends to be affected by a variation of the transformer.

In view of the above-mentioned existing problems, it is an object of the present invention to provide a switching power supply apparatus that can control the overload protection voltage with high precision.

### Solution to Problem

In order to achieve the above-mentioned object, a switching power supply apparatus according to a first aspect of the present invention includes a transformer having a primary winding and a secondary winding; a switching device connected to the primary and configured to perform switching on a first DC voltage supplied to the primary winding; a control circuit configured to control a switching operation of the switching device; an output voltage generation circuit configured to convert an AC voltage into a second DC voltage and to supply the second DC voltage to a load, the AC voltage being generated in the secondary winding by the switching operation of the switching device; a feedback signal generation circuit configured to generate a feedback signal which varies according to the second DC voltage; and a control circuit configured to perform constant-voltage control on the second DC voltage supplied from the output voltage generation circuit by controlling the switching operation of the switching device based on the feedback signal from the feedback signal generation circuit, wherein the control circuit includes: an oscillator configured to generate a clock signal for controlling on-timing of the switching device; a device current detection circuit configured to detect a current flowing through the switching device and to output the current as a device current detection signal; a switching signal control circuit configured to control the second DC voltage to be constant by controlling the switching operation of the switching device based on the clock signal, the device current detection signal, and the feedback signal; a secondary current on-period detection circuit configured to detect timing at which the switching device is turned off and the secondary current flowing through the secondary winding terminates, and to detect a period between the turning off of the switching device and the termination timing of the secondary current, as a secondary current on-period, based on a result obtained by the detection, and to output a signal indicating the detected secondary current on-period; and an output power limiting circuit configured to compare the output signal of the secondary current on-period detection circuit with a signal indicating a predetermined maximum secondary current on-period, and to output an output power limiting signal to the switching signal control circuit, the output power limiting signal for reducing or stopping power supply to the load when the output signal of the secondary current on-period detection circuit is higher than the signal indicating the maximum secondary current on-period, wherein the signal indicating the maximum secondary current on-period is arranged to correspond to the secondary current on-period when the device current flowing through the switching device reaches a maximum current defined by the switching signal control circuit, or an oscillation frequency of the device current reaches a maximum oscillation frequency defined by the oscillator, and then the second DC voltage supplied from the output voltage generation circuit is released from constant-voltage control and reduced.

With this configuration, the secondary current on-period is detected, then its signal and a predetermined signal indicating the maximum secondary current on-period are compared with each other. When the former signal is greater than the latter signal, the power supply to the load is reduced or stopped. Consequently, the overload protection voltage is detected independently of the auxiliary winding voltage, thus the overload protection is performed with high precision.

Here, the transformer may further include an auxiliary winding which generates a voltage proportional to the voltage generated in the secondary winding, and the secondary current on-period detection circuit may be configured to detect timing at which the switching device is turned off and the secondary current flowing through the secondary winding terminates, by detecting the voltage generated in the auxiliary winding.

With this configuration, the secondary current on-period is detected based on the auxiliary winding voltage of the transformer. Thus, without using an expensive unit such as an IC for output current detection on the secondary side or a photo-coupler for overload detection on the secondary side, the circuit of the power supply apparatus can also be formed, thus the power supply apparatus is further reduced in cost and size.

Also, a switching power supply apparatus according to a second aspect of the present invention may further include a continuity/discontinuity determination circuit configured to determine whether a switching operational state of the switching device is either a continuous mode or a discontinuous mode based on an output signal from the secondary current on-period detection circuit and a drive signal of the switching device, wherein the output power limiting circuit is configured to set the maximum secondary current on-period to a different value according to the continuous mode or the discontinuous mode determined by the continuity/discontinuity determination circuit.

With this configuration, a problem that the output current at the time of overload detection in the continuous mode tends to be larger than that in the discontinuous mode can be avoided when the continuous mode and the discontinuous mode occur according to an input voltage to the switching power supply apparatus. That is to say, even in the switching power supply apparatus in which the continuous mode and discontinuous mode occur, the control circuit can identify between the continuous mode and the discontinuous mode and set an appropriate overload detection level according to each mode so that the difference in the output currents at the time of overload detection can be reduced.

Also, a switching power supply apparatus according to a third aspect of the present invention is provided, wherein the feedback signal generation circuit includes an output voltage and current transmission circuit configured to detect the second DC voltage and DC output current from the output voltage generation circuit and to generate the feedback signal which varies according to the second DC voltage until the detected DC output current reaches a predetermined fixed value, and varies according to the DC output current in a state where the DC output current has reached the fixed value, and the control circuit performs constant-voltage control on the second DC voltage until the DC output current reaches the fixed value, and performs constant current control on the DC output current in a state where the DC output current has reached the fixed value by controlling the switching operation of the switching device based on the feedback signal from the feedback signal generation circuit.

With this configuration, a second DC voltage is controlled to be constant until DC output current reaches a fixed value, and DC output current is controlled to be constant in a state where DC output current reaches the fixed value, and power supply by an output power limiting circuit at the time of an overload is reduced or stopped, thus a switching power supply is achieved that is provided with constant-voltage/constant-current characteristic and the Japanese character [symbol] protection function and is used for e.g., a charger.

Also, a switching power supply apparatus according to a fourth aspect of the present invention is provided, wherein the transformer further includes an auxiliary winding which generates a voltage proportional to the voltage generated in the secondary winding, and the feedback signal generation circuit includes an auxiliary power generation circuit configured to generate the feedback signal which varies according to the voltage generated in the auxiliary winding.

With this configuration, without providing an output voltage and current transmission circuit for detecting and transmitting the output voltage and the output current on the secondary side of the transformer, or an output voltage transmission circuit for detecting the output voltage on the secondary side of the transformer, a switching power supply apparatus is achieved that detects the secondary side output voltage and the secondary side output current from the auxiliary winding voltage waveform, and performs constant-voltage/constant-current control through the auxiliary winding feedback.

### Advantageous Effects of Invention

As described above, according to the present invention, even in the case where the circuit current is supplied from the auxiliary winding, it is possible to obtain a stable overload detection voltage which is independent of the set voltage of the auxiliary winding, and is almost free from the influence of the spike voltage of the auxiliary winding due to the leakage inductance of the transformer.

That is to say, according to the present invention, a switching power supply apparatus capable of controlling the overload protection voltage with high precision is achieved.

### [BRIEF DESCRIPTION OF DRAWINGS]

FIG. 1 is a circuit block diagram showing the configuration of a switching power supply apparatus of Embodiment 1 of the present invention.

FIG. 2 are waveform diagrams at respective points showing the operation of the switching power supply apparatus of Embodiment 1.

FIG. 3 is a graph showing the output current-output voltage characteristics in the switching power supply apparatus of Embodiment 1.

FIG. 4 is a circuit block diagram showing another configuration example of the switching power supply apparatus of Embodiment 1.

FIG. 5 is a circuit diagram showing a configuration example of a secondary current on-period detection circuit in the switching power supply apparatus of Embodiment 1.

FIG. 6 is a circuit block diagram showing the configuration of a switching power supply apparatus of Embodiment 2 of the present invention.

FIG. 7 is a circuit diagram showing a configuration example of a continuity/discontinuity determination circuit in the switching power supply apparatus of Embodiment 2.

FIG. 8 shows waveform diagrams at respective points showing the operation of the switching power supply apparatus of Embodiment 2.

FIG. 9 is a circuit block diagram showing the configuration of a switching power supply apparatus of Embodiment 3 of the present invention.

FIG. 10 is a graph showing the output current-output voltage characteristics in the switching power supply apparatus of Embodiment 3, or in a switching power supply apparatus of Embodiment 4.

FIG. 11 is a circuit block diagram showing the configuration of the switching power supply apparatus of Embodiment 4 of the present invention.

FIG. 12 is a circuit block diagram showing the configuration of a secondary duty limiting circuit in the switching power supply apparatus of the Embodiment 4.

FIG. 13 is a circuit block diagram showing the configuration of a conventional switching power supply apparatus.

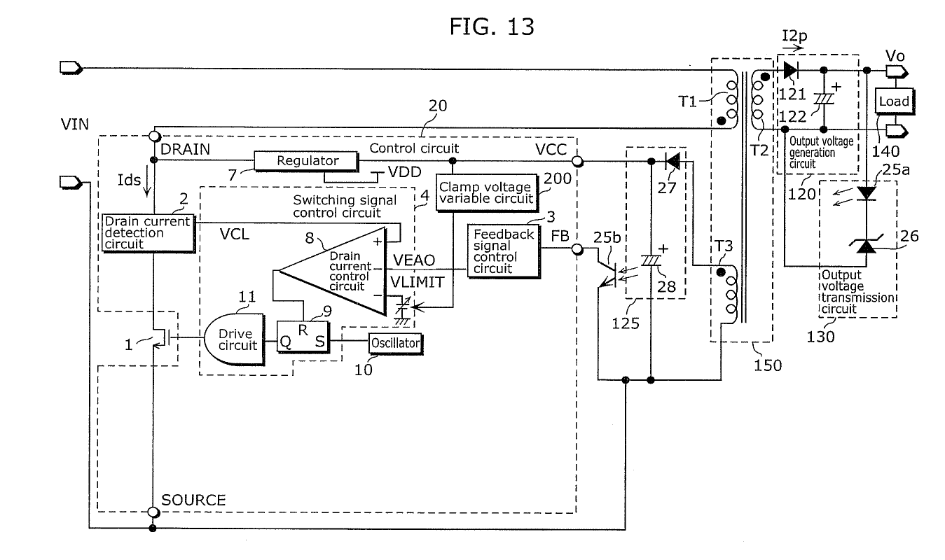

### DESCRIPTION OF EMBODIMENT

Hereinafter, a switching power supply apparatus representing each embodiment of the present invention is specifically described with reference to the drawings.

### Embodiment 1

First, a switching power supply apparatus of Embodiment 1 of the present invention is described.

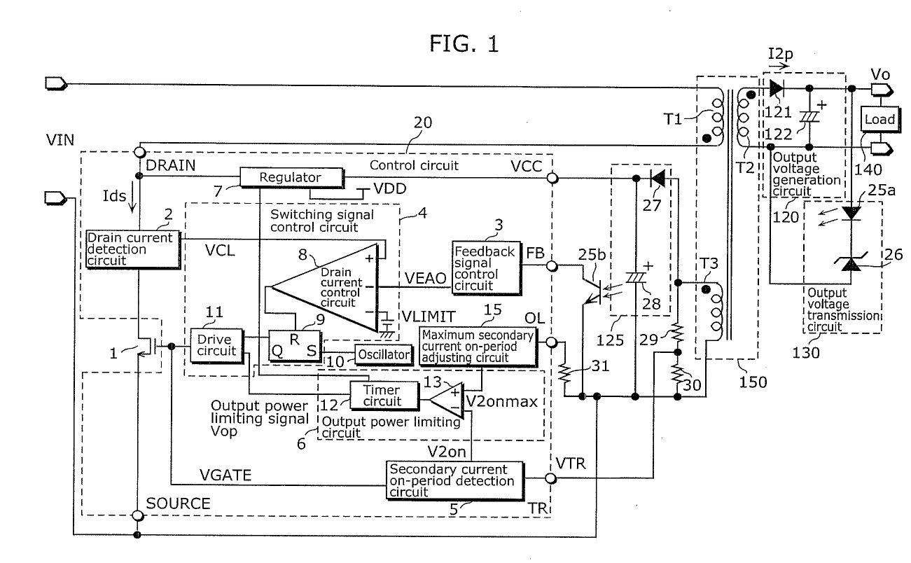

FIG. 1 is a circuit block diagram showing the configuration of the switching power supply apparatus of Embodiment 1. The switching power supply apparatus includes a power conversion transformer 150 having a primary winding T1, a secondary winding T2, and an auxiliary winding T3; a switching device 1 connected to the primary winding T1 and configured to switch a first DC voltage supplied to the primary winding T1; a control circuit 20 configured to control the switching operation of the switching device 1; an output voltage generation circuit 120 configured to convert the AC voltage generated in the secondary winding T2 into a second DC voltage (the output voltage Vo) and to supply it to the load by the switching operation of the switching device 1; and an output voltage transmission circuit 130 configured to detect the second DC voltage from the output voltage generation circuit 120 and to generate a feedback signal which varies according to the second DC voltage, and to transmit the feedback signal to the control circuit 20, wherein the second DC voltage from the output voltage generation circuit 120 is controlled to be constant by the control of the switching operation of the switching device 1 of the control circuit 20.

In the present embodiment, there is formed a feedback signal generation circuit with the output voltage transmission circuit 130 (including a photo-coupler 25b to be paired with a photo-coupler 25a), the feedback signal generation circuit being configured to generate a feedback signal (signal inputted to a terminal FB of the control circuit 20) which varies according to the second DC voltage (output voltage Vo).

The control circuit 20 is formed as an integrated circuit, for example, on a semiconductor chip, and includes an oscillator 10 configured to generate a clock signal for controlling on-timing of the switching device 1; a drain current detection circuit 2 configured to detect the current flowing through the switching device 1 and to output the current as a device current detection signal; a feedback signal control circuit 3 configured to convert the feedback signal (current signal) inputted to the terminal FB into a voltage and to output the voltage as a feedback control signal VEAO; a switching signal control circuit 4 configured to control the second DC voltage (output voltage Vo) from the output voltage generation circuit 120 to be constant by controlling the switching operation of the switching device 1 based on the clock signal from the oscillator 10, the device current detection signal from the drain current detection circuit 2, and the feedback control signal VEAO from the feedback signal control circuit 3; a secondary current on-period detection circuit 5 configured to detect the timing when the switching device 1 is turned off and then the secondary current flowing through the secondary winding T2 terminates based on the voltage generated in the auxiliary winding T3 by the switching operation of the switching device 1, and to detect the time between the turning off of the switching device 1 and the off timing of the secondary current, as a secondary current on-period, based on the result obtained by the detection, and to output a signal (a secondary current on-period signal V2on) indicating the detected secondary current on-period; and an output power limiting circuit 6 configured to compare the output signal of the secondary current on-period detection circuit 5 with a predetermined signal indicating the maximum secondary current on-period, and to output an output power limiting signal to the switching signal control circuit 4, the output power limiting signal for reducing or stopping power supply to the load when the output signal of the secondary current on-period detection circuit 5 is greater than the maximum secondary current on-period.

The maximum secondary current on-period signal corresponds to the secondary current on-period when the device current flowing through the switching device 1 reaches the maximum current defined by the switching signal control circuit 4, or the oscillation frequency of the device current reaches the maximum oscillation frequency defined by the oscillator 10, and then the second DC voltage (output voltage Vo) from the output voltage generation circuit 120 is released from constant-voltage control and reduced.

Hereinafter, each component is described in detail.

As shown in FIG. 1, the power conversion transformer 150 has the primary winding T1, the secondary winding T2, and the auxiliary winding T3. The polarity of the secondary winding T2 is the reverse polarity of the primary winding T1, and the switching power supply apparatus serves as a flyback power supply.

One terminal of the primary winding T1 of the power conversion transformer 150 is connected to the positive terminal of the input side (primary side) of the switching power supply apparatus, and the other terminal of the primary winding T1 is connected to the negative terminal of the input side (primary side) of the switching power supply apparatus via the switching device 1 which serves as a semiconductor device of high resistance voltage.

The switching device 1 has an input terminal, an output terminal, and a control terminal; the input terminal is connected to the primary winding T1; and the output terminal is connected to the negative terminal of the input side of the switching power supply apparatus. Also, the switching device 1 is switched (oscillated) so that the input terminal and the output terminal are electrically connected or disconnected in response to a control signal applied to the control terminal. A power MOSFET is used as the switching device 1, for example.

By the switching operation (oscillation operation) of the switching device 1, the DC voltage (the first DC voltage) VIN supplied to the primary winding T1 from the terminal of the input side of the switching power supply apparatus is converted into a pulse voltage (high-frequency voltage), while the pulse voltage is transferred to the secondary winding T2 and the auxiliary winding T3. The polarity of the auxiliary winding T3 is the same as that of the secondary winding T2, and the pulse voltage generated in the auxiliary winding T3 is proportional to that generated in the secondary winding T2.

In this manner, by the switching operation of the switching device 1 connected to the primary winding T1 to which the DC voltage VIN is supplied, voltages of the secondary winding T2 and the auxiliary winding T3 of the power conversion transformer 150 are generated, the voltages depending on respective number of turns ratio between the respective windings and the primary winding T1.

The secondary winding T2 of the power conversion transformer 150 is connected to the output voltage generation circuit 120. The output voltage generation circuit 120 generates the secondary output voltage (the second DC voltage) Vo from the AC voltage generated in the secondary winding T2. Specifically, the output voltage generation circuit 120 includes a rectifier diode 121 and a smoothing capacitor 122, and the pulse voltage generated in the secondary winding T2 is rectified and smoothed by the rectifier diode 121 and the smoothing capacitor 122 so that the output voltage Vo is generated. The output voltage Vo is supplied to a load 140 connected to a terminal of the output side (secondary side) of the switching power supply apparatus.

Also, the output voltage transmission circuit 130 is connected to the output voltage generation circuit 120. The output voltage transmission circuit 130 includes a photo-coupler 25a, a voltage detection circuit 26, and a photo-coupler 25b to be paired with the photo-coupler 25a. An output voltage level generated by the output voltage generation circuit 120 is detected by the photo-couplers 25a and the voltage detection circuit 26, and is converted into an optical signal, then is transmitted to the photo-coupler 25b provided on the primary side. The optical signal is outputted from the photo-coupler 25b to the terminal FB as a feedback signal.

The auxiliary winding T3 of the power conversion transformer 150 is connected to the auxiliary power generation circuit 125. Specifically, the auxiliary power generation circuit 125 includes a rectifier diode 27 and a smoothing capacitor 28, and generates the auxiliary power voltage VCC from the generated voltage of the auxiliary winding T3, then supplies the circuit current for the control circuit 20 from the VCC terminal.

The switching operation of the switching device 1 is controlled by the control circuit 20. The control circuit 20 includes semiconductor devices (semiconductor devices for switching power supply) formed on the same semiconductor substrate, and has 6 terminals of a DRAIN terminal, a VCC terminal, an FB terminal, a TR terminal, an OL terminal, and a SOURCE terminal as external connection terminals as shown.

The DRAIN terminal is connected to the primary winding T1 of the power conversion transformer 150, and the input terminal of the switching device 1 is connected to the primary winding T1 via the DRAIN terminal. The VCC terminal is connected to the auxiliary power generation circuit 125, and the auxiliary power voltage VCC is applied to the VCC terminal. The SOURCE terminal is connected to the negative terminal of the input side of the switching power supply apparatus, and the output terminal of the switching device 1 is connected to the negative terminal of the input side of the switching power supply apparatus via the SOURCE terminal.

The control circuit 20 generates a control signal to be applied to the control terminal of the switching device 1 based on the voltage (auxiliary power voltage VCC) of the VCC terminal, and controls the switching operation of the switching device 1.

Hereinafter, the internal configuration of the control circuit 20 is described.

A regulator 7 is connected to the VCC terminal and the DRAIN terminal in the control circuit 20. The regulator 7 supplies current to a power supply VDD for internal circuits of the control circuit 20 from either the DRAIN terminal or the VCC terminal, and stabilizes the voltage of the power supply VDD for internal circuits to a fixed value.

That is to say, before the switching device 1 starts a switching operation, the regulator 7 supplies current to the power supply VDD for internal circuits from the DRAIN terminal, while supplying current also to the smoothing capacitor 28 via the VCC terminal so that the auxiliary power voltage VCC and the voltage of the power supply VDD for internal circuits are increased.

Also, after the switching device 1 starts the switching operation, the regulator 7 stops the current supply from the DRAIN terminal to the VCC terminal. That is to say, when the auxiliary power voltage VCC has at least a fixed value, the regulator 7 supplies the current based on the auxiliary power voltage VCC from the VCC terminal to the power supply VDD for internal circuits. When the auxiliary power voltage VCC falls below a fixed value, and cannot supply current to the power supply VDD for internal circuits, it is maintained by the current supply from the DRAIN terminal. In this manner, it is effective in reducing the power consumption to supply the circuit current of the control circuit 20 from the auxiliary winding T3, and in order to secure the stability of the control circuit, it is indispensable to maintain the constant power supply VDD for internal circuits by the current from the DRAIN terminal even after the auxiliary power voltage VCC decreases.

The photo-coupler 25b is connected to the terminal FB. The terminal FB serves as a control terminal (an input terminal of a feedback signal) for feedback control.

The feedback signal control circuit 3 detects, as a feedback signal, a current value (signal level) flowing into the photo-coupler 25b through the terminal FB, and generates the feedback control signal VEAO which is a voltage signal depends on the detected current value.

The feedback control signal VEAO which is an output signal of the feedback signal control circuit 3 formed in the above manner is supplied to a drain current control circuit 8 of the switching signal control circuit 4.

The oscillator (oscillating circuit) 10 oscillates a clock signal for turning on the switching device 1, with a constant period. The clock signal is inputted into the set terminal of an RS latch circuit 9 of the switching signal control circuit 4.

The switching signal control circuit 4 turns on the switching device 1 at a timing according to the signal oscillated by the oscillator 10, and turns off the switching device 1 at a timing according to the signal level of the feedback control signal VEAO from the feedback signal control circuit 3.

Specifically, the switching signal control circuit 4 includes the drain current control circuit 8, the RS latch circuit 9, and a drive circuit 11.

The drain current detecting circuit (device current detection circuit) 2 is arranged between the DRAIN terminal and the input terminal of the switching device 1 to detect the current value of a current (drain current) ID flowing to the switching device 1, and generates a drain current detection signal (device current detection signal) VCL of the voltage value according to the current value. The drain current detection signal VCL is supplied to the drain current control circuit 8 in the switching signal control circuit 4.

An overcurrent protection reference voltage VLIMIT, and the feedback control signal VEAO from the feedback signal control circuit 3 are supplied as reference voltages to the drain current control circuit 8. When the drain current detection signal VCL reaches the lower voltage between the overcurrent protection reference voltage VLIMIT and the feedback control signal VEAO, the drain current control circuit 8 generates a signal for turning off the switching device 1. This signal is inputted to the reset terminal R of the RS latch circuit 9.

The RS latch circuit 9 receives a clock signal from the oscillator 10 as an input to the set terminal S, and receives a signal from the drain current control circuit 8 as an input to the reset terminal R, then generates a signal for turning on the switching device 1 in a period between when a set state is activated and when the subsequent reset state is activated. That is to say, turn-on of the switching device 1 is controlled by the clock signal from the oscillator 10, and the turn-off of the switching device 1 is controlled by the signal from the drain current control circuit 8.

The drive circuit 11 generates a control signal for drive-controlling the switching operation of the switching device 1 based on the signal from the Q terminal generated in the RS latch circuit 9, and the output power limiting signal VOP generated in the output power limiting circuit 6.

The RS latch circuit 9 then outputs a clock signal and a basic control signal by the drain current control circuit. In normal operation time, the output power limiting circuit 6 outputs a Low level output signal, however, once an overload is detected, and a certain time period elapses, then a High level is outputted as the output power limiting signal VOP, the drive circuit 11 outputs Low and the oscillation is stopped. The drive circuit 11 is configured by, for example, a latch circuit.

The auxiliary winding T3 is connected to the TR terminal via series splitting resistances 29, 30, and is connected to the secondary current on-period detection circuit 5 in the control circuit 20.

The secondary current on-period detection circuit 5 is a circuit for detecting the timing when the switching device 1 is turned off upon detection of the voltage generated in the auxiliary winding T3, and then the secondary current flowing through the secondary winding T2 terminates. Specifically, the secondary current on-period detection circuit 5 is also connected to the drive circuit 11 to detect the pulse voltage which appears in the auxiliary winding T3, and a time period (a secondary current on-period T2on) during which current flows from an output signal VGATE of the drive circuit 11 to the secondary winding T2 of the power conversion transformer 150. The secondary current on-period detection circuit 5 converts the time period into a voltage level to generate a secondary current on-period signal V2on which is a signal indicating the secondary current on-period, then outputs the secondary current on-period signal V2on to the output power limiting circuit 6.

The output power limiting circuit 6 is configured to control the device current flowing through the switching device 1 according to the secondary current on-period after the secondary current on-period has reached the maximum secondary current on-period. More particularly, the secondary current on-period signal V2on from the secondary current on-period detection circuit 5 is compared with the signal indicating the predetermined maximum secondary current on-period (a maximum secondary current on-period signal V2onmax from a maximum secondary current on-period adjusting circuit 15), and when the former current on-period is greater than the latter current on-period, the output power limiting circuit 6 outputs the output power limiting signal VOP to the drive circuit 11 of the switching signal control circuit 4, the output power limiting signal VOP for reducing or stopping power supply to the load. The output power limiting circuit 6 includes a timer circuit 12 and a secondary current on-period comparison circuit 13. The secondary current on-period comparison circuit 13 is connected to the maximum secondary current on-period adjusting circuit 15 and the secondary current on-period detection circuit 5.

The maximum secondary current on-period adjusting circuit 15 controls the maximum secondary current on-period signal V2onmax according to the current or the voltage of an external OL terminal.

In such a configuration, connecting, for example, a resistor 31 as an external device to the OL terminal enables the maximum secondary current on-period signal V2onmax to be externally adjusted.

The operation of the output power limiting circuit 6 is as follows. That is to say, when the secondary current on-period signal V2on from the secondary current on-period detection circuit 5 reaches the maximum secondary current on-period signal V2onmax, the output of the secondary current on-period comparison circuit 13 is inverted, and the timer circuit 12 starts its operation. When the output of secondary current on-period comparison circuit 13 is maintained for a certain time period (timer period) after the output of the secondary current on-period comparison circuit 13 is inverted, the timer circuit 12 outputs the output power limiting signal VOP to the drive circuit 11. That is to say, the output power limiting circuit 6 outputs the output power limiting signal VOP in the case where the secondary current on-period reaches the maximum secondary current on-period, then a state is maintained where the secondary current on-period is greater than the maximum secondary current on-period for a certain time period.

Accordingly, at the time of an overload on the secondary side, the overload is detected by the auxiliary winding T3 and the secondary current on-period detection circuit 5, and when the overloaded state is further maintained for a certain time period (timer period) after the overload detection, the present switching power supply apparatus is deactivated in a safe manner by the output power limiting signal VOP.

Here, the intermittent control system and the timer latch system are generally known as the operational system of the timer circuit 12 which operates as an overload protection function.

In the intermittent control system, the signal of the RS latch circuit 9 is disabled for a certain time period to stop the switching operation of the switching device 1, but subsequently, is enabled for a relatively short time period to allow the switching operation. In the case where the overloaded state is released within the time period during which the signal of the RS latch circuit 9 is enabled, the switching operation resumes to normal operation. In the case where the overloaded state is not released within the time period during which the signal of the RS latch circuit 9 is enabled, the signal of the RS latch circuit 9 is disabled again for a certain time period to stop the switching operation. That is to say, the above-described cycle is repeated until the overloaded state is released or the input is separated.

In the case of the timer latch system, disabled state of the RS latch circuit 9 is not released unless an external operation such as separation of the input is performed after the signal of the RS latch circuit 9 is disabled by the output power limiting signal VOP.

Also, the regulator 7 controls activation and deactivation of the control circuit 20, and activation/deactivation signal is inputted to the timer circuit 12, and the operation thereof is disabled for a certain time period when the control circuit 20 is activated.

Accordingly, at the time of activation, an activation failure which may be caused by an erroneous detection of the overload before the start-up of output can be prevented.

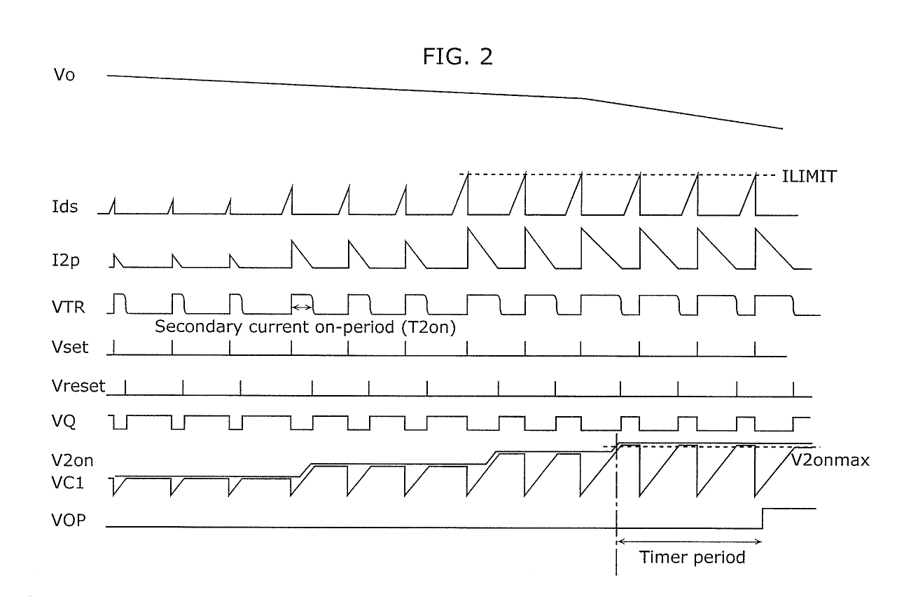

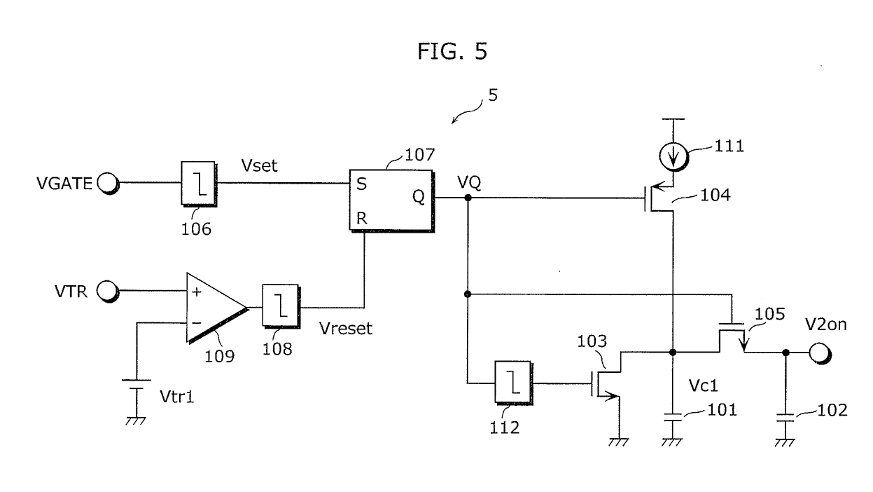

FIG. 2 is a time chart showing the timing between a device current Ids of the switching device 1, a current I2p flowing through the secondary winding T2, an input voltage VTR of the TR terminal, the secondary current on-period signal V2on, and the output power limiting signal VOP as the load is gradually increased in the switching power supply apparatus of the present Embodiment 1. In FIG. 2, the waves of various signals Vset, Vreset, VQ, VC1 in the secondary current on-period detection circuit 5 indicated in the later-described FIG. 5 are also collectively shown.

In FIG. 2, the more the load is increased and the output voltage Vo is gradually decreased, the more the device current Ids is reduced, and when the device current Ids reaches a maximum device current ILIMIT, the output voltage Vo starts to decrease rapidly than ever. It is configured such that the secondary current on-period signal V2on reaches the maximum secondary current on-period signal V2onmax when the device current Ids reaches the maximum device current ILIMIT and subsequently the output voltage Vo is reduced. Then after the secondary current on-period signal V2on reaches the maximum secondary current on-period signal V2onmax, and a certain time period (“timer period”) elapses, the output power limiting signal VOP (which is HIGH) is outputted.

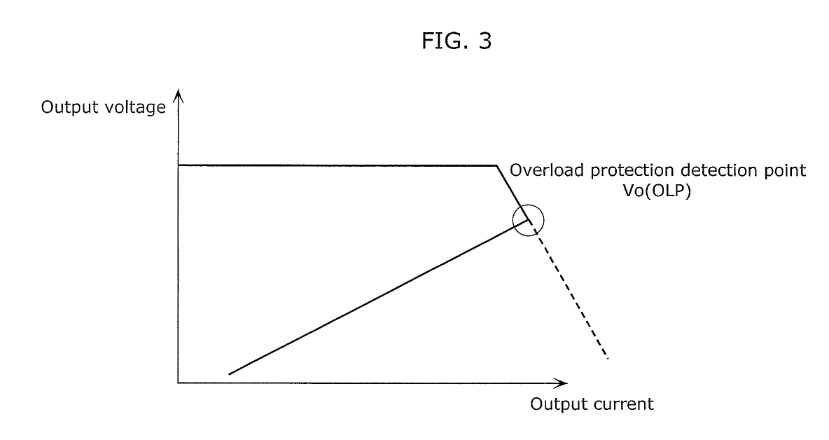

FIG. 3 is a graph showing the output current-output voltage characteristics in the switching power supply apparatus of Embodiment 1.

The following Expressions 2 shows the relationship between the output voltage Vo and the secondary current on-period T2on in the discontinuous mode; L2 indicates the inductance of the secondary winding T2 of the transformer; and I2p indicates the current flowing through the secondary winding T2.

$$\begin{matrix}[ MATH 2 ] & \\ Vo = \frac{L 2 \times I 2 p}{T 2 on} & ( Expression 2 )\end{matrix}$$

Assuming that the primary side device current is Ids, and the numbers of turns of the primary winding and the secondary winding of the transformer are N1 and N2, respectively, the current I2p flowing through the secondary winding T2 is expressed by

$$\begin{matrix}[ MATH 3 ] & \\ I 2 p = \frac{Ids \times N 1}{N 2} & ( Expression 3 )\end{matrix}$$

In the present invention, when the overload protection function operates, the device current Ids becomes the maximum device current ILIMIT which is defined by the drain current control circuit 8.

In other words, this shows that when the overload protection function operates, the current I2p flowing through the secondary winding T2 can be considered to be a constant defined by the control circuit, the output voltage Vo can be controlled as a function of the secondary current on-period T2on.

Also, in FIG. 1, the secondary current on-period is detected using the auxiliary winding T3 of the power conversion transformer 150, however, the secondary current on-period is detected by monitoring the voltage of the DRAIN terminal of the switching device 1.

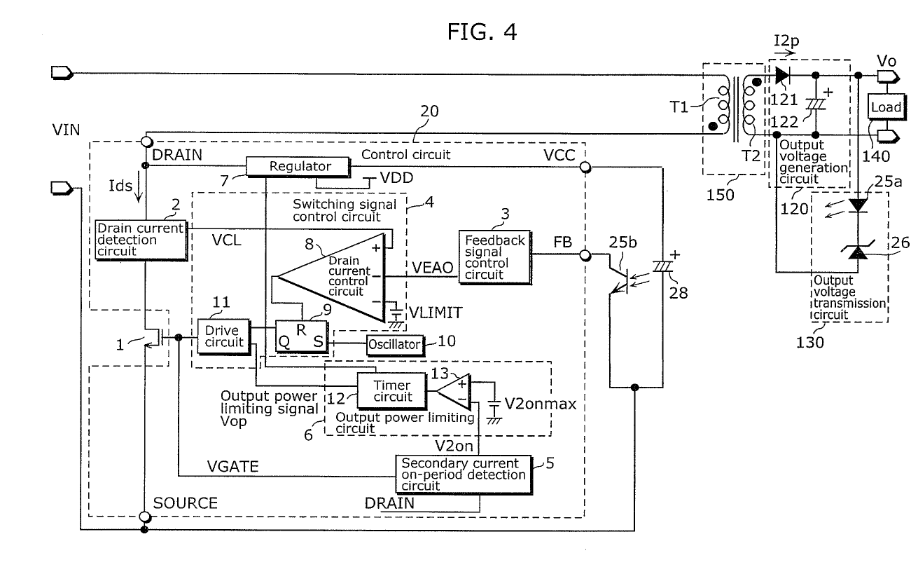

FIG. 4 shows, as another configuration example of Embodiment 1 in FIG. 1, a switching power supply apparatus that detects a signal of the secondary current on-period from the DRAIN terminal without using the auxiliary winding T3. As shown in FIG. 4, in this configuration example, the secondary current on-period detection circuit 5 detects the timing (the secondary current on-period T2on) when the switching device 1 is turned off and then the secondary current flowing through the secondary winding T2 terminates by detecting the voltage generated in the input terminal (the DRAIN terminal) connected to the primary winding T1 among the terminals included in the switching device 1, and converts the timing into a voltage level to generate the secondary current on-period signal V2on, then outputs the secondary current on-period signal V2on to the output power limiting circuit 6.

As shown in FIG. 4, when detecting directly from the DRAIN terminal, the input terminal of the secondary current on-period detection circuit needs to be resistant against high voltage, and current supply from the Drain terminal of the high voltage and not from the auxiliary power voltage VCC having a relatively low voltage has a disadvantage in that power consumption on the primary side is increased, but has a favorable effect in that the total cost of the power source can be lowered by reducing the number of external circuit components.

In this case, although high voltage resistant devices are needed for the secondary current on-period detection circuit 5, the auxiliary winding T3 of the transformer can be eliminated, thus the transformer can be reduced in size.

Also, in FIG. 4, there is no T2MAX terminal, and the maximum secondary current on-period signal V2onmax is fixed in the control circuit. In this manner, parts of peripheral circuits can be reduced in number.

FIG. 5 shows a configuration example of the secondary current on-period detection circuit 5 in the switching power supply apparatus of Embodiment 1 shown in FIG. 1.

The secondary current on-period detection circuit 5 includes pulse generators 106, 108, 112, an RS latch circuit 107, a comparator (comparison circuit) 109, NchMOSFET 103, 105, PchMOSFET 104, capacitors (condensers) 101, 102, and a constant current supply 111.

A reference voltage Vtr1 is inputted to the negative input of the comparator 109, and VTR is inputted from TR terminal to the positive input, then an output is inputted to R (reset) terminal of the RS latch circuit 107 via the pulse generator 108. Accordingly, flyback voltage waveform VTR of the auxiliary winding T3 inputted to the TR terminal generates a pulse signal Vreset by the comparator 109 and the pulse generator 108 when VTR is smaller than Vtr1.

VGATE which is an input signal to the switching device 1 is inputted to an S (set) terminal of the RS latch circuit 107 via the pulse generator 106, and the pulse generator 106 generates a pulse signal Vset at the timing when the switching device 1 is turned off.

That is to say, upon receiving the Vset signal, Vreset signal, the RS latch circuit 107 turns off the switching device 1, and outputs a signal VQ which is High during a period until the TR terminal detects that the secondary current terminates.

The output VQ of the RS latch circuit 107 is connected to the gate of the NchMOSFET 105 and the gate of the PchMOSFET 104, and is further connected to the gate of the NchMOSFET 103 via the pulse generator 112.

The pulse generator 112 generates a convex pulse signal at the timing when the input signal VQ becomes Low from High, i.e., turns on the NchMOSFET 103 every time the switching device 1 is turned off.

The drain terminals of the NchMOSFET 103, 105 are connected to the capacitor 101, and also the source terminal of the NchMOSFET 105 is connected to the capacitor 102. In addition, the capacitor 101 is connected to the constant current supply 111 via the PchMOSFET 104.

The waveforms at respective points in the secondary current on-period detection circuit 5 configured in this manner are shown in FIG. 2.

According to FIG. 2, every time the switching device 1 is turned off, the NchMOSFET 103 is turned on momentarily to discharge the electric charge charged in the capacitor 101.

The PchMOSFET 104 is turned on in the secondary current on-period, and during the period, the capacitor 101 is charged by the constant current supply 111.

In contrast to the PchMOSFET 104, the NchMOSFET 105 is turned on only in a period during which no current flows through the secondary transformer, and transfers the voltage signal of the charged capacitor 101 to the capacitor 102.

That is to say, the potential level of the capacitor 101 is varied in proportion to the secondary current on-period for each pulse, and is transferred to the capacitor 102 when the secondary current terminates, then the potential (V2on) of the capacitor 102 is maintained until the subsequent secondary current on-period expires.

Thus, the secondary current on-period detection circuit 5 in the switching power supply apparatus of Embodiment 1 converts the secondary current on-period T2on into a voltage signal pulse by pulse, the secondary current on-period T2on variable for each pulse.

As such, according to Embodiment 1, the secondary current on-period detection circuit 5 is configured to detect the timing when the switching device 1 is turned off and then the secondary current flowing through the secondary winding T2 terminates based on the voltage generated in the auxiliary winding T3 by the switching operation of the switching device 1, and to detect the time between the turning off of the switching device 1 and the off timing of the secondary current, as a secondary current on-period, based on the result obtained by the detection; and the output power limiting circuit 6 is configured to compare the output signal of the secondary current on-period detection circuit 5 with a predetermined signal indicating the maximum secondary current on-period, and to output an output power limiting signal to the switching signal control circuit 4, the output power limiting signal for reducing or stopping power supply to the load when the output signal of the secondary current on-period detection circuit 5 is greater than the maximum secondary current on-period.

Thus, even in the case where the circuit current is supplied from the auxiliary winding, it is possible to obtain a stable overload detection voltage which is independent of the set voltage of the auxiliary winding, and is almost free from the influence of the spike voltage of the auxiliary winding due to the leakage inductance of the transformer. Furthermore, with such a configuration that the secondary current on-period is detected based on the auxiliary winding voltage of the transformer, the circuit of the power supply apparatus can also be formed without using an expensive part on the secondary side, thus the power supply apparatus can be further reduced in cost and size.

### Embodiment 2

Next, a switching power supply apparatus of Embodiment 2 of the present invention is described.

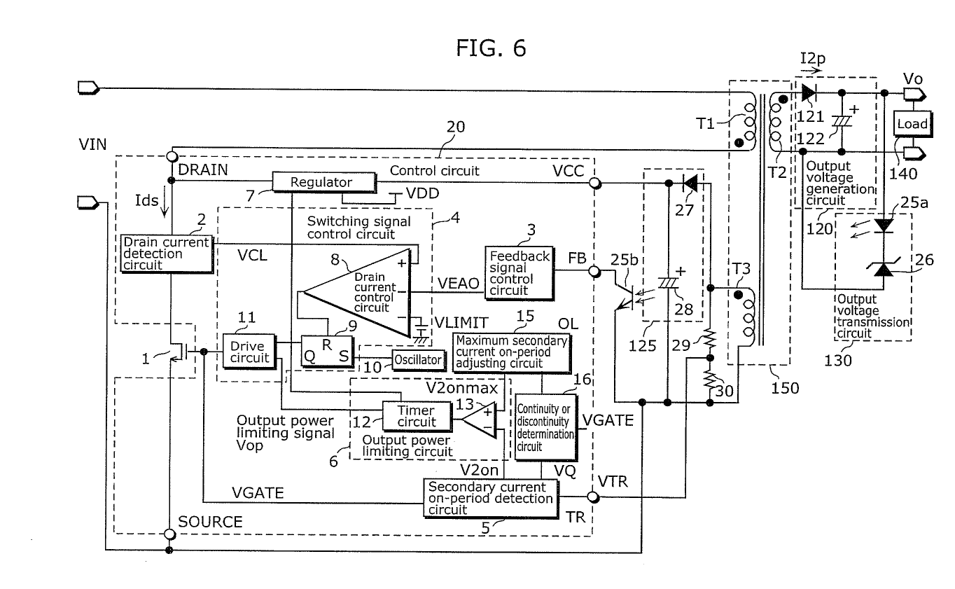

FIG. 6 is a block diagram showing a configuration example of the switching power supply apparatus of Embodiment 2 of the present invention. However, the members in Embodiment 2 corresponding to the above-described members in Embodiment 1 are labeled with the same reference symbols and description is omitted.

In addition to the configuration of Embodiment 1, the switching power supply apparatus of the present embodiment has a function of determining whether the switching operational state of the switching device 1 is either continuous mode or discontinuous mode based on an output signal from the secondary current on-period detection circuit 5 and a drive signal of the switching device 1, and of setting the maximum secondary current on-period to a different value according to each mode. Hereinafter, the aspect of Embodiment 2 which is different from that of Embodiment 1 is described in detail.

The switching power supply apparatus includes a maximum secondary current on-period adjusting circuit 15, and a continuity/discontinuity determination circuit 16 in the control circuit 20. The maximum secondary current on-period adjusting circuit 15 is connected to the continuity/discontinuity determination circuit 16. Furthermore, the continuity/discontinuity determination circuit 16 is connected to the secondary current on-period detection circuit 5.

The continuity/discontinuity determination circuit 16 determines whether the switching power supply apparatus is in continuous mode or in discontinuous mode based on the output signal VGATE of the drive circuit 11 and the signal VQ which is one of the output signals of the secondary current on-period detection circuit 5. When the switching power supply apparatus is determined to be in continuous mode, a control signal Vq1 is outputted to the maximum secondary current on-period adjusting circuit 15 so as to reduce the maximum secondary current on-period signal V2onmax. As described in Embodiment 1, the signal VQ is set to High only in a period until the switching device 1 is turned off, and the secondary current flowing through the secondary winding T2 terminates.

Specifically, the continuity/discontinuity determination circuit 16 compares the signal VGATE with the inverted signal VQB of the signal VQ. In the case where there is a certain time period during which the signal VGATE and the signal VQB are simultaneously ON, the current mode is determined to be continuous mode, otherwise, to be discontinuous mode. The continuous mode (or discontinuous mode) means an operational mode in which the current flowing through the switching power supply apparatus (the power conversion transformer 150 in a strict sense) becomes continuous (or discontinuous).

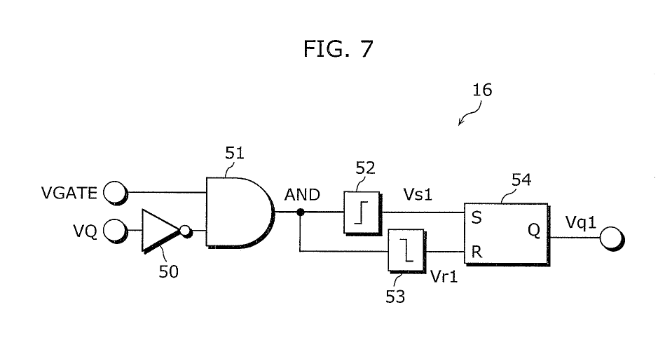

FIG. 7 is a circuit diagram showing a configuration example of the continuity/discontinuity determination circuit 16 in the switching power supply apparatus of Embodiment 2.

As shown in FIG. 7, the continuity/discontinuity determination circuit 16 includes an inverter 50, an AND circuit 51, pulse generators 52, 53 and an RS latch circuit 54. When an input signal is set from Low to High, the pulse generator 52 generates a convex pulse as a signal Vs1, while when an input signal is set from High to Low, the pulse generator 53 generates a convex pulse as a signal Vr1.

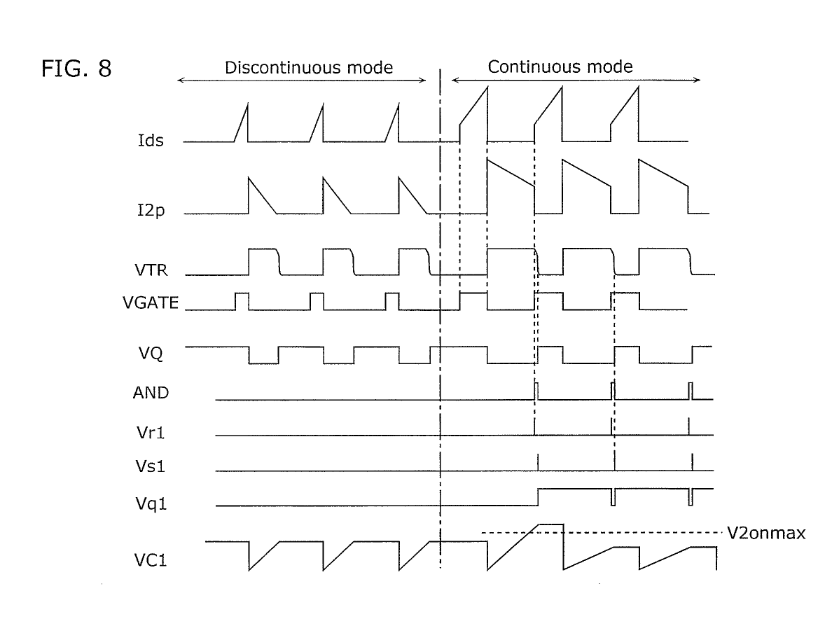

FIG. 8 shows timing charts of the waveforms at respective points for illustrating the operation of the continuity/discontinuity determination circuit 16 of FIG. 7, and indicates time charts of a gate voltage VGATE of the switching device 1, the device current Ids, the current I2p flowing through the secondary winding T2, the input voltage VTR of the TR terminal, an output AND of the AND circuit 51 of the continuity/discontinuity determination circuit 16, input signals Vr1, Vs1 and an output signal Vq1 of the RS latch circuit 54, a voltage signal VC1 of the capacitor 101 of the secondary current on-period detection circuit 5, and an output VQ of the RS latch circuit 107 in continuous mode and in discontinuous mode.

In this manner, the signal Vq1 for determining continuous mode or discontinuous mode is obtained based on the drive signal VGATE of the switching device 1 and the signal VQ indicating the secondary current on-period from the secondary current on-period detection circuit 5. The signal Vq1 is reset every time the switching device 1 is turned on for each pulse, and is set to Low momentarily, however, immediately resumes to High while continuous mode is detected.

While the signal Vq1 is High, reducing the current of the constant current supply 111 of the secondary current on-period detection circuit 5 causes a smaller conversion rate between the secondary current on-period of the secondary current on-period detection circuit 5 and the corresponding voltage, thus the maximum secondary current on-period as the reference value for detecting an overload is increased.

In the above-described Embodiment 1, the output current at the time of overload detection can be controlled with high precision as long as in discontinuous mode, however, when continuous mode and discontinuous mode occur because of input voltages, the output current at the time of overload detection in continuous mode tends to be larger than in discontinuous mode.

On the other hand, because the continuity/discontinuity determination circuit 16 is provided in Embodiment 2, even in the switching power supply apparatus for which the continuous mode and discontinuous mode occur, the control circuit 20 can identify between the continuous mode and the discontinuous mode to set an appropriate overload detection level according to each mode so that the difference in the output currents at the time of the overload detection can be reduced.

### Embodiment 3

Next, a switching power supply apparatus of Embodiment 3 of the present invention is described.

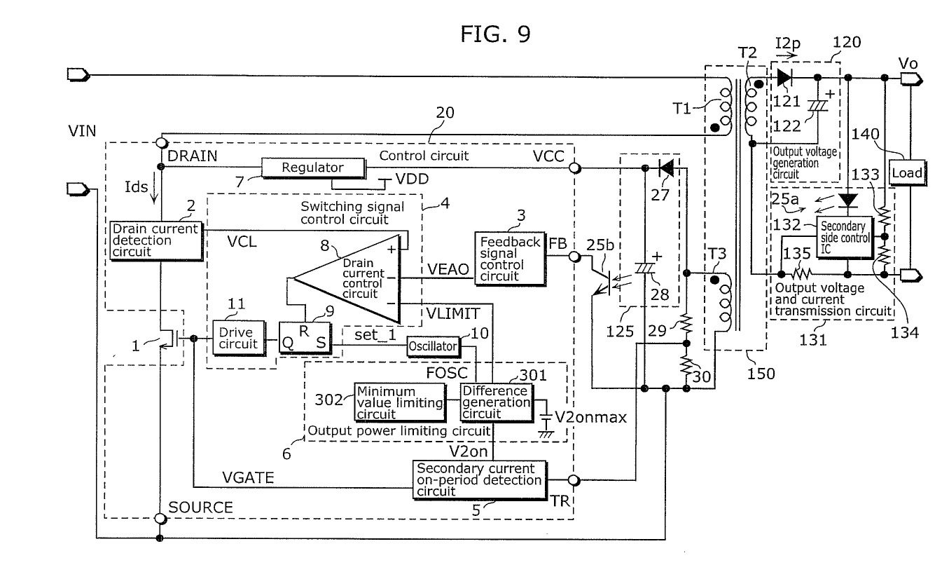

FIG. 9 is a block diagram showing the configuration of the switching power supply apparatus of Embodiment 3. However, the members in Embodiment 3 corresponding to the above-described members in Embodiment 1 are labeled with the same reference symbols and description is omitted.

The switching power supply apparatus includes the power conversion transformer 150 having a primary winding T1, the secondary winding T2, and an auxiliary winding T3; the switching device 1 configured to switch a first DC voltage connected to the primary winding T1 and supplied thereto; the control circuit 20 configured to control the switching operation of the switching device 1; the output voltage generation circuit 120 configured to convert the AC voltage generated in the secondary winding T2 into a second DC voltage (output voltage Vo) and to supply it to the load by the switching operation of the switching device 1; and an output voltage current transmission circuit 131 configured to detect DC output voltage and DC output current from the output voltage generation circuit 120, and to generate and transmit a feedback signal to the control circuit 20, the feedback signal variable according to the second DC voltage until the detected DC output current reaches a predetermined fixed value, and the feedback signal variable according to DC output current in a state where DC output current reaches the fixed value, wherein the second DC voltage from the output voltage generation circuit 120 is controlled to be constant while DC output current is controlled to be constant by the control of the switching operation of the switching device 1 of the control circuit 20.

In the present embodiment, there is formed a feedback signal generation circuit with the output voltage transmission circuit 131 (including the photo-coupler 25b to be paired with the photo-coupler 25a), the feedback signal generation circuit being configured to generate a feedback signal (signal inputted to the terminal FB of the control circuit 20) which varies according to the second DC voltage (the output voltage Vo) and DC output current.

The control circuit 20 includes the oscillator 10 configured to generate a clock signal for controlling on-timing of the switching device 1; the drain current detection circuit 2 configured to detect the current flowing through the switching device 1 and to output the current as a device current detection signal; the feedback signal control circuit 3 configured to convert the feedback signal (current signal) inputted to the terminal FB into a voltage and to output the voltage as a feedback control signal VEAO; a switching signal control circuit 4 configured to control the second DC voltage (the output voltage Vo) to be constant until DC output current from the output voltage generation circuit 120 reaches a fixed value, and to control DC output current to be constant in a state where DC output current reaches the fixed value by controlling the switching operation of the switching device 1 based on the clock signal from the oscillator 10, the device current detection signal from the drain current detection circuit 2, and the feedback control signal VEAO from the feedback signal control circuit 3; the secondary current on-period detection circuit 5 configured to detect the timing when the switching device 1 is turned off and then the secondary current flowing through the secondary winding T2 terminates based on the voltage generated in the auxiliary winding T3 by the switching operation of the switching device 1, and to detect the time between the turning off of the switching device 1 and the off timing of the secondary current, as a secondary current on-period, based on the result obtained by the detection, and to output the signal (the secondary current on-period signal V2on) indicating the detected secondary current on-period; and an output power limiting circuit 6 configured to compare the output signal of the secondary current on-period detection circuit 5 with a predetermined signal indicating the maximum secondary current on-period, and to output an output power limiting signal to the switching signal control circuit 4, the output power limiting signal for reducing or stopping power supply to the load when the output signal of the secondary current on-period detection circuit 5 is greater than the maximum secondary current on-period. Hereinafter, each component is described in detail.

Instead of the output voltage transmission circuit 130 provided in Embodiment 1 configured to detect the output voltage on the secondary side and transmit it to the primary side, the switching power supply apparatus includes the output voltage current transmission circuit 131 configured to detect and transmit the output voltage and the output current on the secondary side, wherein the output power limiting circuit 6 has a difference generation circuit 301 and a minimum value limiting circuit 302.

The output voltage current transmission circuit 131 includes the photo-coupler 25a, a secondary control IC 132, and resistors 133, 134, 135, and is configured to transmit a signal according to the output voltage Vo to the primary side via the photo-coupler 25a until a secondary side output current Io reaches a fixed value, and to transmit a signal according to the secondary side output current Io to the primary side via the photo-coupler 25a once the secondary side output current Io reaches the fixed value. Accordingly, the switching operation of the switching device 1 is controlled based on the signal transmitted from the output voltage current transmission circuit 131, thus the output voltage Vo is controlled to be constant until the secondary side output current Io reaches a fixed value, and the secondary side output current Io is controlled to be constant in a state where the secondary side output current Io reaches the fixed value.

Consequently, in Embodiment 3, constant-voltage/constant-current control is performed by the secondary control IC 132.

The output power limiting circuit 6 includes the difference generation circuit 301 and the minimum value limiting circuit 302. The difference generation circuit 301 is connected to the drain current control circuit 8 and the oscillator 10 to receive the maximum secondary current on-period signal V2onmax and the secondary current on-period signal V2on as input signals, and controls the overcurrent protection reference voltage VLIMIT according to the difference between the maximum secondary current on-period signal V2onmax and the secondary current on-period signal V2on when the former signal exceeds the latter signal.

The minimum value limiting circuit 302 is configured to set a lower limit of the overcurrent protection reference voltage VLIMIT, and the difference generation circuit 301 is configured to control the oscillation frequency FOSC of the oscillator 10 once the overcurrent protection reference voltage VLIMIT reaches the lower limit. Accordingly, not only the device current Ids flowing through the switching device 1 is controlled by the output power limiting circuit 6 according to the secondary current on-period after the secondary current on-period has reached the maximum secondary current on-period, but also the oscillation frequency FOSC of the oscillator 10 is controlled according to the secondary current on-period once the device current Ids of the switching device 1 reaches a predetermined minimum device current.

Thus, in Embodiment 3, as the secondary current on-period T2on is increased, the device current Ids is reduced, and once the device current Ids is reduced to a certain level (the minimum device current), the frequency FOSC is further reduced as the secondary current on-period T2on is increased so that the output power is reduced as much as possible.

In this manner, the Japanese character [symbol] protection can be achieved that is often used for e.g., a charger of a portable device.

Here, the difference generation circuit 301 first controls the overcurrent protection reference voltage VLIMIT, then controls the oscillation frequency FOSC, however, in contrast to this, the difference generation circuit 301 may first control the oscillation frequency FOSC, then may control the overcurrent protection reference voltage VLIMIT, and still similar effects may be obtained. That is to say, the output power limiting circuit 6 may be configured to control the oscillation frequency FOSC of the oscillator 10 according to the secondary current on-period after the secondary current on-period has reached the maximum secondary current on-period, and to control the device current Ids flowing through the switching device 1 according to the secondary current on-period once the oscillation frequency further reaches a predetermined minimum frequency.

Also, the output power may be reduced to some extent by controlling only either the overcurrent protection reference voltage VLIMIT or the oscillation frequency FOSC.

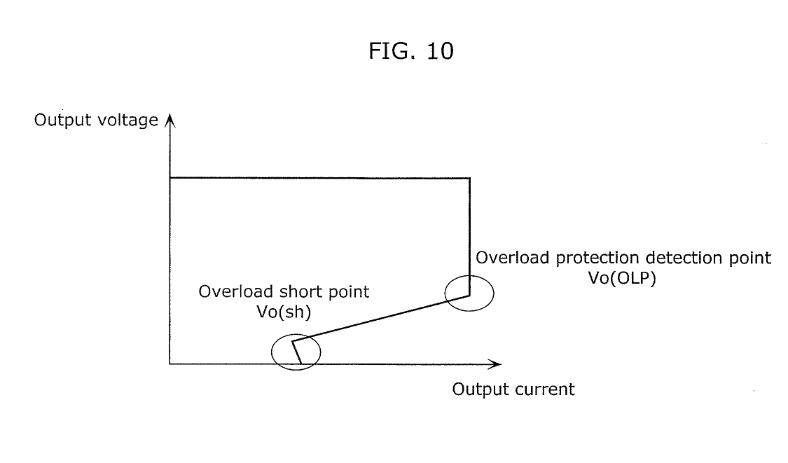

FIG. 10 shows the constant-voltage/constant-current characteristics used for e.g., a charger, and the output characteristics of the switching power supply provided with the Japanese character [symbol] protection function.

As described above, in FIG. 10, according to the present embodiment, the output voltage at the overload detection point P1 can be stably set, and also with the Japanese character [symbol] protection function, the output power can be reduced to load short-circuit point Vo(sh) as much as possible at the time of load short-circuit.

### Embodiment 4

Next, a switching power supply apparatus of Embodiment 4 of the present invention is described.

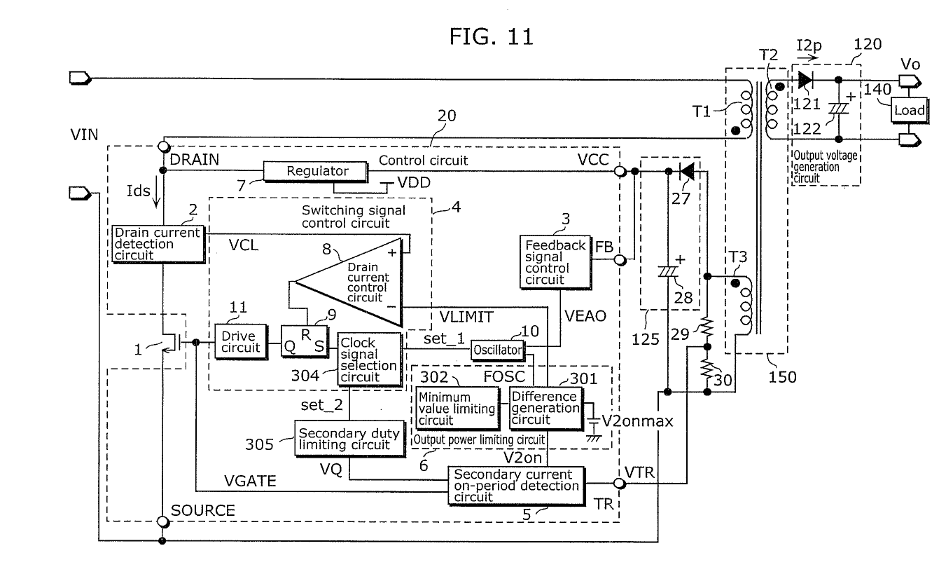

FIG. 11 is a block diagram showing a configuration example of the switching power supply apparatus of Embodiment 4. However, the members in Embodiment 4 corresponding to the above-described members in Embodiments 1, 3 are labeled with the same reference symbols and description is omitted.

The switching power supply apparatus includes the power conversion transformer 150 having a primary winding T1, the secondary winding T2, and an auxiliary winding T3; the switching device 1 configured to switch a first DC voltage connected to the primary winding T1 and supplied thereto; the control circuit 20 configured to control the switching operation of the switching device 1; the output voltage generation circuit 120 configured to convert the AC voltage generated in the secondary winding T2 into a second DC voltage (output voltage Vo) and to supply it to the load by the switching operation of the switching device 1; and an auxiliary power generation circuit 125 configured to generate and transmit a feedback signal to the control circuit 20, the feedback signal variable according to the auxiliary winding T3 voltage signal of the auxiliary winding T3, which generates a voltage waveform proportional to the voltage generated in the secondary winding T2, wherein similarly to Embodiment 3, the second DC voltage from the output voltage generation circuit 120 is controlled to be constant while DC output current is controlled to be constant by the control of the switching operation of the switching device 1 of the control circuit 20.

In the present embodiment, there is formed a feedback signal generation circuit with the auxiliary winding T3 and the auxiliary power generation circuit 125, the feedback signal generation circuit being configured to generate a feedback signal (signal inputted to the terminal FB of the control circuit 20) which varies according to the second DC voltage (the output voltage Vo).

The control circuit 20 includes the oscillator 10 configured to generate a clock signal for controlling on-timing of the switching device 1; the drain current detection circuit 2 configured to detect the current flowing through the switching device 1 and to output the current as a device current detection signal; the secondary current on-period detection circuit 5 configured to detect the timing when the switching device 1 is turned off and then the secondary current flowing through the secondary winding T2 terminates based on the voltage generated in the auxiliary winding T3 by the switching operation of the switching device 1, and to detect the time between the turning off of the switching device 1 and the off timing of the secondary current, as a secondary current on-period, based on the result obtained by the detection, and to output the signal (the secondary current on-period signal V2on) indicating the detected secondary current on-period; a switching signal control circuit 4 configured to control the second DC voltage from the output voltage generation circuit 120 to be constant as well as DC output current to be constant by controlling the ON and OFF operations of the switching device 1 according to the output of the auxiliary power generation circuit 125; and an output power limiting circuit 6 configured to compare the output signal of the secondary current on-period detection circuit 5 with a predetermined signal indicating the maximum secondary current on-period, and to output an output power limiting signal to the switching signal control circuit 4, the output power limiting signal for reducing or stopping power supply to the load when the output signal of the secondary current on-period detection circuit 5 is greater than the maximum secondary current on-period. Hereinafter, each component is described in detail.

In Embodiment 4, the switching power supply apparatus does not include an output voltage and current transmission circuit for detecting and transmitting the output voltage and the output current on the secondary side of the transformer, or an output voltage transmission circuit for detecting the output voltage on the secondary side, however, achieves constant-voltage/constant-current control by detecting the secondary side output voltage, the secondary side output current from the auxiliary winding voltage waveform, and consequently performing constant-voltage/constant-current control through the auxiliary winding feedback similarly to Embodiment 3.

Also, particularly here, description is given based on the system introduced also in Patent Literature 2, which performs constant current control by maintaining a constant ratio between the secondary current on-period T2on and the switching period T of the switching device 1.

In the present embodiment, the FB terminal is connected to the output terminal of the auxiliary power generation circuit 125 along with the VCC terminal. The feedback signal control circuit 3 receives a feedback signal (herein, the auxiliary power voltage VCC which is an output of the auxiliary power generation circuit 125) inputted to the FB terminal, and controls the oscillator 10 based on the input by outputting the feedback control signal VEAO. Specifically, the feedback signal control circuit 3 controls the frequency of a clock signal for turning on the switching device 1, the clock signal being generated by the oscillator 10 according to the auxiliary power voltage VCC. Accordingly, constant-voltage control by the frequency control of the auxiliary winding feedback is performed.

Also, the output signal VQ of the secondary current on-period detection circuit 5 is connected to a secondary duty limiting circuit 305.

The outputs of the oscillator 10 and the secondary duty limiting circuit 305 are connected to a clock signal selection circuit 304, and the output of the clock signal selection circuit 304 is connected to the set terminal S of the RS latch circuit 9.

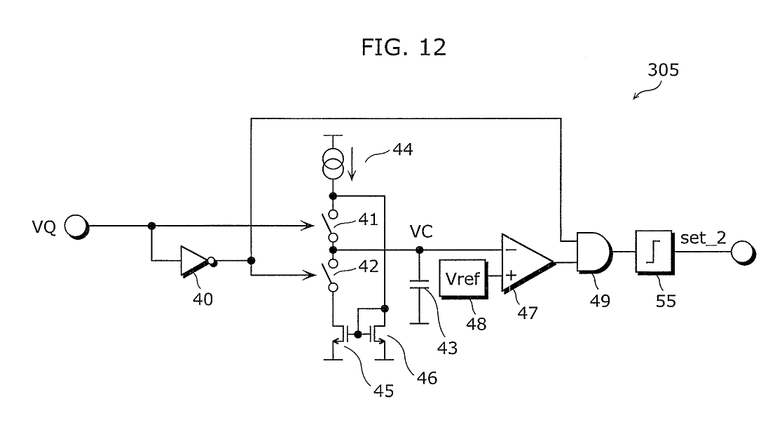

FIG. 12 shows a configuration example of the secondary duty limiting circuit 305.

The secondary duty limiting circuit 305 receives, as an input, the output signal VQ of the secondary current on-period detection circuit 5, and detects the period between the timing of turning off the switching device 1 and the timing when the secondary current terminates, then outputs a clock signal set_2 (a second clock signal) for turning on the switching device 1 to the clock signal selection circuit 304 at the timing when an on-duty of the secondary current (hereinafter referred to as a secondary current on-duty) becomes constant with a predetermined value.

In other words, the output signal set₂ of the secondary duty limiting circuit 305 serves as a clock signal for determining the timing of turning on the switching device 1 so as to maintain the secondary current on-duty with a predetermined value, and the frequency of the clock signal is reduced as the current flowing through the load 140 is increased and the on-period of the secondary current (the period during which the secondary current flows) is extended. The clock signal set_2 determines the oscillation frequency of the switching device 1 in a constant current region and the Japanese character [symbol] protection region.

The clock signal selection circuit 304 receives, as inputs, an output signal set_1 from the oscillator 10 and the output signal set_2 from the secondary duty limiting circuit 305 outputs a signal with a lower frequency, i.e., with a longer period to the drive circuit 11 via the RS latch circuit 9.

That is to say, when the load is low and the first clock signal set_1 has a frequency lower (not higher) than the second clock signal set_2, the clock signal selection circuit 304 outputs the first clock signal set_1, while when the load is high and the first clock signal set_1 has a frequency not lower (or higher) than the second clock signal set_2, the clock signal selection circuit 304 outputs the second clock signal set_2 to the drive circuit 11 via the RS latch circuit 9.

Thus, the clock signal selection circuit 304 outputs the first clock signal set_1 to the drive circuit 11 via the RS latch circuit 9 when the secondary current on-duty is lower than a predetermined value, but outputs the second clock signal set_2 to the drive circuit 11 via the RS latch circuit 9 when the load becomes higher and the secondary current on-duty reaches the predetermined value so that the secondary current on-duty is maintained with the predetermined value.

The secondary duty limiting circuit 305 includes an inverter 40, switches 41, 42, a condenser (capacitor) 43, constant current supply 44, NchMOSFET 45, 46, a comparator (comparison circuit) 47, a reference voltage source 48, an AND circuit 49, and a pulse generator 55. The devices are connected to each other as shown in FIG. 12.

The switch 41 is turned on when the output signal VQ of the secondary current on-period detection circuit 5 becomes high-level, and is turned off when the output signal VQ becomes low-level. Also, the switch 42 is turned on when the signal from the inverter 40 becomes high-level, and is turned off when the signal becomes low-level.

A charge and discharge circuit including the switches 41 and 42 charges the capacitor 43 with a constant current of the constant current source 44 in a period during which the switch 41 is on and the switch 42 is off. In addition, the charge and discharge circuit discharges the capacitor 43 in a period during which the switch 41 is off and the switch 42 is on.

As described above, the capacitor 43 is charged with the constant current of the constant current source 44 in a period during which a predetermined time elapses between the turn off of the switching device 1 and the subsequent off timing (fall timing of the TR terminal voltage VTR) of the secondary current detected by the secondary current on-period detection circuit 5, so that the voltage VC of the capacitor 43 is increased. The charging current at this moment is determined by the constant current of the constant current source 44.

Also, the capacitor 43 is discharged in a period between the off timing (fall timing of the TR terminal voltage VTR) of the secondary current detected by the secondary current on-period detection circuit 5 and the subsequent turning off of the switching device 1, so that the voltage VC of the capacitor 43 is decreased. The discharging current at this moment is determined by a current mirror circuit including the constant current of the constant current source 44 and NchMOSFET 45, 46.

The comparator 47 generates a signal for turning on the switching device 1 at the timing of detecting the decreased voltage VC of the capacitor 43 with a reference voltage (set voltage) Vref generated in the reference voltage source 48, so that one pulse signal is generated in the pulse generator 55. The one pulse signal serves as the second clock signal set_2. The AND circuit 49 is configured to generate the one pulse signal in the pulse generator 55 only in a period during which an input signal VQ is low-level.

In this manner, the secondary duty limiting circuit 305 charges the capacitor 43 in a period during which a predetermined time elapses between the turn off of the switching device 1 and the subsequent off timing (fall timing of the TR terminal voltage VTR) of the secondary current detected by the secondary current on-period detection circuit 5. The secondary duty limiting circuit 305 starts to discharge the capacitor 43 at the off timing (fall timing of the TR terminal voltage VTR) of the secondary current detected by the secondary current on-period detection circuit 5, and turns on the switching device 1 upon detecting the voltage VC of the capacitor 43 with the reference voltage Vref. Even after turning on the switching device 1, the secondary duty limiting circuit 305 continues to discharge the capacitor 43 until the peak value of the drain current Ids reaches a fixed value and the switching device 1 is turned off.

With the configuration described above, the secondary duty limiting circuit 305 outputs the second clock signal (one pulse signal) set_2 for turning on the switching device 1 so that the on-duty of the secondary current is maintained at a predetermined value.

Subsequently, a clock signal selection function is described. This function is achieved by the clock signal selection circuit 304. The clock signal selection circuit 304 selects a signal with a lower frequency, i.e., with a longer period between the first clock signal set_1 outputted by the oscillator 10 and the second clock signal set_2 oscillated by the secondary duty limiting circuit 305, then inputs the signal to the set terminal of the RS latch (flip-flop) circuit 9.

Consequently, the clock signal selection circuit 304 selects the first clock signal set_1 in a constant voltage region in which the on-duty of the secondary current has not reached a fixed value because the frequency of the first clock signal set_1 is lower than that of the second clock signal set_2 in the constant voltage region. On the other hand, the clock signal selection circuit 304 selects the second clock signal set_2 in a constant current region in which the load 140 is higher than a certain level and the on-duty of the secondary current has reached a fixed value because the frequency of the second clock signal set_2 is lower than that of the first clock signal set_1 in the constant current region. Consequently, either constant-voltage control or constant-current control is selected according to the load on the secondary side.

While the constant current control is performed by the secondary duty limiting circuit 305, the above-mentioned Expression 2 holds.

The constant current control is achieved by maintaining the relationship of the above-mentioned Expression 2.

Subsequently, the output power limiting circuit 6 is described.

The output power limiting circuit 6 includes the difference generation circuit 301 and the minimum value limiting circuit 302. The difference generation circuit 301 is connected to the drain current control circuit 8 and the oscillator 10 to receive the maximum secondary current on-period signal V2onmax and the secondary current on-period signal V2on as input signals, and controls the overcurrent protection reference voltage VLIMIT which is an input of the drain current control circuit 8, according to the difference between the V2onmax and the V2on when the former signal exceeds the latter signal.

The minimum value limiting circuit 302 is configured to set a lower limit of the overcurrent protection reference voltage VLIMIT, and the difference generation circuit 301 is configured to control the oscillation frequency of the oscillator 10 once the overcurrent protection reference voltage VLIMIT reaches the lower limit.

That is to say, as the overcurrent protection reference voltage VLIMIT is reduced, the secondary current I2p is also reduced in proportion to the VLIMIT, and the output current Io is reduced based on Expression 2. In addition, as the period T is reduced, the output current Io is further reduced.

In this manner, the Japanese character [symbol] protection is achieved.

As described above, according to Embodiments 1 to 4, even in the case where the circuit current is supplied from the auxiliary winding, it is possible to obtain a stable overload detection voltage which is independent of the set voltage of the auxiliary winding, and is almost free from the influence of the spike voltage of the auxiliary winding due to the leakage inductance of the transformer. Furthermore, with such a configuration that the secondary current on-period is detected based on the auxiliary winding voltage of the transformer, the circuit of the power supply apparatus can also be formed without using an expensive part on the secondary side, thus the power supply apparatus can be further reduced in cost and size.

In the above, the switching power supply apparatus according to one aspect of the present invention has been described based on Embodiments 1 to 4, however, the present invention is not limited to these Embodiments. As long as not departing from the spirit of the present invention, modified embodiments obtained by making various modifications, which occur to those skilled in the art, to these embodiments, and other embodiments obtained by arbitrarily combining the components of the embodiments are also included in the scope of the present invention.

### INDUSTRIAL APPLICABILITY

In the switching power supply apparatus according to one aspect of the present invention, without using an expensive part such as an IC for output current detection on the secondary side or a photo-coupler for overload detection on the secondary side, the circuit of the power supply apparatus can be formed, thus the power supply apparatus can be further reduced in cost and size. The switching power supply apparatus is useful for power supply device such as a charging circuit for portable electronic devices, for which constant-voltage control function and overload protection function are desired.

### REFERENCE SIGNS LIST

1 Switching device
2 Drain current detection circuit (device current detection circuit)
3 Feedback signal control circuit
4 Switching signal control circuit
5 Secondary Current On-period Detection Circuit
6 Output power limiting circuit
7 Regulator
8 Drain current control circuit
9, 54, 107 RS latch circuit
10 Oscillator
11 Drive circuit
12 Timer circuit
13 Secondary current on-period comparison circuit
15 Maximum secondary current on-period adjusting circuit
16 Continuity/discontinuity determination circuit
20 Control circuit
25a, 25b Photo-coupler
26 Voltage detection circuit
27, 121 Rectifier diode
28, 122 Smoothing capacitor
29, 30, 31, 133, 134, 135 Resistor
40 Inverter
41, 42 Switch
43, 101, 102 Capacitor
44 Constant current source
45, 46, 103, 105 NchMOSFET
47, 109 Comparator (comparison circuit)
48 Reference voltage source
49, 51 AND circuit
50 Inverter
52, 53, 55, 106, 108, 112 Pulse generator
104 PchMOSFET
111 Constant current source
120 Output voltage generation circuit
125 Auxiliary power generation circuit
130 Output voltage transmission circuit
131 Output voltage and current transmission circuit
132 Secondary control IC
140 Load
150 Power conversion transformer
301 Difference generation circuit
302 Minimum value limiting circuit
304 Clock signal selection circuit
305 Secondary duty limiting circuit

1-14. (canceled)

15. A switching power supply apparatus comprising:
a transformer including a primary winding and a secondary winding;
a switching device connected to said primary winding and configured to perform switching on a first DC voltage supplied to said primary winding;
an output voltage generation circuit configured to convert an AC voltage into a second DC voltage and to supply the second DC voltage to a load, the AC voltage being generated in said secondary winding by the switching operation of said switching device;
a feedback signal generation circuit configured to generate a feedback signal which varies according to the second DC voltage; and
a control circuit configured to perform constant-voltage control on the second DC voltage supplied from said output voltage generation circuit by controlling the switching operation of said switching device based on the feedback signal from said feedback signal generation circuit,
wherein said control circuit includes:
an oscillator configured to generate a clock signal for controlling on-timing of said switching device;
a device current detection circuit configured to detect a current flowing through said switching device and to output the current as a device current detection signal;
a switching signal control circuit configured to control the second DC voltage to be constant by controlling the switching operation of said switching device based on the clock signal, the device current detection signal, and the feedback signal;
a secondary current on-period detection circuit configured to detect timing at which said switching device is turned off and the secondary current flowing through said secondary winding terminates, and to detect a period between the turning off of said switching device and the termination timing of the secondary current, as a secondary current on-period, based on a result obtained by the detection, and to output a signal indicating the detected secondary current on-period; and
an output power limiting circuit configured to compare the output signal of said secondary current on-period detection circuit with a signal indicating a predetermined maximum secondary current on-period, and to output an output power limiting signal to said switching signal control circuit, the output power limiting signal for reducing or stopping power supply to the load when the output signal of said secondary current on-period detection circuit is higher than the signal indicating the maximum secondary current on-period,
wherein the signal indicating the maximum secondary current on-period is arranged to correspond to the secondary current on-period when the device current flowing through said switching device reaches a maximum current defined by said switching signal control circuit, or an oscillation frequency of the device current reaches a maximum oscillation frequency defined by said oscillator, and then the second DC voltage supplied from said output voltage generation circuit is released from constant-voltage control and reduced.

16. The switching power supply apparatus according to claim 15,
wherein said feedback signal generation circuit includes an output voltage transmission circuit configured to detect the second DC voltage from said output voltage generation circuit and to generate the feedback signal which varies according to the detected second DC voltage.

17. The switching power supply apparatus according to claim 15,
wherein said feedback signal generation circuit includes an output voltage and current transmission circuit configured to detect the second DC voltage and DC output current from said output voltage generation circuit and to generate the feedback signal which varies according to the second DC voltage until the detected DC output current reaches a predetermined fixed value, and varies according to the DC output current in a state where the DC output current has reached the fixed value, and
said control circuit performs constant-voltage control on the second DC voltage until the DC output current reaches the fixed value, and performs constant current control on the DC output current in a state where the DC output current has reached the fixed value by controlling the switching operation of said switching device based on the feedback signal from said feedback signal generation circuit.

18. The switching power supply apparatus according to claim 15,
wherein said transformer further includes an auxiliary winding which generates a voltage proportional to the voltage generated in said secondary winding, and
said feedback signal generation circuit includes an auxiliary power generation circuit configured to generate the feedback signal which varies according to the voltage generated in said auxiliary winding.

19. The switching power supply apparatus according to claim 15,
wherein said transformer further includes an auxiliary winding which generates a voltage proportional to the voltage generated in said secondary winding, and
said secondary current on-period detection circuit is configured to detect timing at which said switching device is turned off and the secondary current flowing through said secondary winding terminates, by detecting the voltage generated in said auxiliary winding.

20. The switching power supply apparatus according to claim 15,
wherein said secondary current on-period detection circuit is configured to detect timing at which said switching device is turned off and the secondary current flowing through said secondary winding terminates, by detecting a voltage generated at a terminal out of terminals included in said switching device, the terminal being connected to said primary winding.

21. The switching power supply apparatus according to claim 15,
wherein said output power limiting circuit is configured to output the output power limiting signal in the case where the secondary current on-period reaches the maximum secondary current on-period, then a state is maintained for a certain time period where the secondary current on-period is greater than the maximum secondary current on-period.

22. The switching power supply apparatus according to claim 15, further comprising
a continuity/discontinuity determination circuit configured to determine whether a switching operational state of said switching device is either a continuous mode or a discontinuous mode based on an output signal from said secondary current on-period detection circuit and a drive signal of said switching device,
wherein said output power limiting circuit is configured to set the maximum secondary current on-period to a different value according to the continuous mode or the discontinuous mode determined by said continuity/discontinuity determination circuit.

23. The switching power supply apparatus according to claim 15,
wherein said output power limiting circuit is configured to control the device current flowing through said switching device according to the secondary current on-period after the secondary current on-period has reached the maximum secondary current on-period.

24. The switching power supply apparatus according to claim 15,
wherein said output power limiting circuit is configured to control an oscillation frequency of the oscillator according to the secondary current on-period after the secondary current on-period has reached the maximum secondary current on-period.

25. The switching power supply apparatus according to claim 15,
wherein said output power limiting circuit is configured to control the device current flowing through said switching device according to the secondary current on-period after the secondary current on-period has reached the maximum secondary current on-period, and to control an oscillation frequency of the oscillator according to the secondary current on-period in the case where the device current of said switching device further reaches a predetermined minimum device current.

26. The switching power supply apparatus according to claim 15,
wherein said output power limiting circuit is configured to control an oscillation frequency of the oscillator according to the secondary current on-period after the secondary current on-period has reached the maximum secondary current on-period, and to control the device current flowing through said switching device according to the secondary current on-period once the oscillation frequency further reaches a predetermined minimum frequency.

27. The switching power supply apparatus according to claim 15,
wherein said control circuit further includes a timer circuit configured to disable said output power limiting circuit for a certain time period after an oscillation starts.

28. The switching power supply apparatus according to claim 15,
wherein said control circuit is further formed on a semiconductor chip, and includes a terminal for externally adjusting the maximum secondary current on-period.
